(19) United States
(12) Patent Application Publication
(10) Pub. No.: US 2012/0166251 A1
(43) Pub. Date: Jun. 28, 2012

(54) SERVER AND METHOD FOR PROVIDING AFFILIATE STORE INFORMATION

(75) Inventors: Jung-Hwa ROH, Gyeonggi-do (KR); Jang-Hyuk LEE, Yeongdeungpo-gu (KR); Jeong-Hwan KIM, Seoul (KR); Jeong Kyu JANG, Incheon (KR)

(73) Assignee: KOREA INFORMATION & COMMUNICATIONS CO., LTD., Seoul (KR)

(21) Appl. No.: 13/226,748

(22) Filed: Sep. 7, 2011

(30) Foreign Application Priority Data
Dec. 28, 2010 (KR) 10-2010-0136165

(51) Int. Cl. G06Q 10/00

(52) U.S. Cl. 705/7.29

(57) ABSTRACT

A server and method for providing affiliate store information are provided, in which a receiver collects transaction count information being information about the number of transactions made in each affiliate store and receives search condition information from a mobile communication terminal, a database stores affiliate store information generated based on the collected transaction count information, a generator extracts the affiliate store information of at least one affiliate store by searching the database according to the search condition information received through the receiver and generates search result using the extracted affiliate store information, and a transmitter transmits the search result to the mobile communication terminal.

### CLAIM OF PRIORITY

This application claims priority under 35 U.S.C. §119(a) to a Korean Patent Application filed in the Korean Intellectual Property Office on Dec. 28, 2010 and assigned Serial No. 10-2010-0136165, the contents of which are incorporated herein by reference.

### BACKGROUND OF THE INVENTION

1. Field of the Invention

The present invention relates to a server for providing affiliate store information, and more particularly, to a server and method for providing information about an affiliate store based on at least one of the number of credit card transactions and the number of cash transactions made in the affiliate store.

2. Description of the Related Art

Mobile communication terminals have recently been evolved to provide a variety of additional functions including video call, message transmission, image transmission, etc. As such, a mobile communication terminal can wirelessly access the Internet and thus download, store, and play back multimedia data such as a directory, a photo animation, a video, bell sounds, etc. as well as receive a Web service.

A wide range of other applications are under development for installation and execution in mobile communication terminals. For example, an application that introduces or recommends best restaurants by location or by region have become widely popular. Such an application has a drawback in that it is typically based on subjective data. For instance, an application may introduce best stores according to customers' reviews, customers' recommendations, experts' opinions, or media coverage which in return may induce customers into visiting the stores. However, the subjective data is vulnerable to commercial exploitation or abuse, and as such, and may provide incorrect or unintended information to customers due to its subjectiveness.

### SUMMARY OF THE INVENTION

An aspect of embodiments of the present invention is to address at least the problems and/or disadvantages and to provide at least the advantages described below. Accordingly, an aspect of embodiments of the present invention is to provide a server and method for providing information about an affiliate store based on at least one of the number of credit card transactions and the number of cash transactions made in the affiliate store.

Another aspect of embodiments of the present invention is to provide a server and method for providing information about an affiliate store based on at least one of the number of credit card transactions and the number of cash transactions made in the affiliate store, so that a user may identify or evaluate an affiliate store by actual number of customers visited.

In accordance with an embodiment of the present invention, there is provided a server for providing affiliate store information are provided, in which a receiver collects transaction count information relating to a number of transactions made in each affiliate store and receives search condition information from a mobile communication terminal, a database stores affiliate store information generated based on the collected transaction count information according to a predetermined criteria, a generator extracts the affiliate store information of at least one affiliate store from the database according to the search condition information and generates a search result using the extracted affiliate store information, and a transmitter transmits the search result to the mobile communication terminal.

The generator may check the number of transactions made in the at least one affiliate store using the extracted affiliate store information and may generate the search result by arranging the extracted affiliate store information according to the checked number of transactions.

If the number of affiliate stores corresponding to the extracted affiliate store information exceeds a threshold, the generator may select affiliate store information of as many the affiliate stores as the threshold from the extracted affiliate store information according to the numbers of transactions made in the affiliate stores.

The threshold may be received in the search condition information from the mobile communication terminal, or may be preset by an operator of the server.

The generator may extract the affiliate store information of the at least one affiliate store from the database using at least one of terminal location information of the mobile communication terminal and search location information, the terminal location information and the search location information being acquired from the search condition information.

The generator may calculate the distance between the at least one affiliate store corresponding to the extracted affiliate store information and at least one of a terminal location indicated by the terminal location information and a search location indicated by the search location information and may comprise information about the distance in the search result.

If the number of affiliate stores corresponding to the extracted affiliate store information exceeds a threshold, the generator may select affiliate store information of as many affiliate stores as the threshold from the extracted affiliate store information according to the information about the distance.

The generator may extract affiliate store information of at least one affiliate store matching the received search condition information from among affiliate stores located within a predetermined range, from the database.

The transaction count information may comprise at least one of the number of credit card transactions and the number of cash transactions.

The affiliate store information may comprise at least one of affiliate store name information, phone number information, address information, business type information, menu information, price information, business hour information, and parking availability information.

In accordance with another embodiment of the present invention, there is provided a method for providing affiliate store information in a server, in which affiliate store information is generated based on collected transaction count information of each affiliate store, the transaction count information relating to the number of transactions made in the affiliate store and managed in a database, the affiliate store information of at least one affiliate store is extracted from a database according to search condition information received from a mobile communication terminal, and a search result is generated using the extracted affiliate store information and transmitted to the mobile communication terminal.

To generate the search result, the number of transactions made in the at least one affiliate store may be checked using the extracted affiliate store information, the extracted affiliate store information may be arranged according to the checked number of transactions, and the search result may be generated using the arranged affiliate store information.

If the number of affiliate stores corresponding to the extracted the affiliate store information exceeds a threshold, affiliate store information of as many affiliate stores as the threshold may be selected from the extracted affiliate store information according to the numbers of transactions made in the affiliate stores.

The threshold may be received in the search condition information from the mobile communication terminal, or may be preset by an operator of the server.

To extract the affiliate store information, the affiliate store information of the at least one affiliate store may be extracted from the database using at least one of terminal location information of the mobile communication terminal and search location information, the terminal location information and the search location information being acquired from the search condition information.

To generate the search result, the distance between the at least one affiliate store corresponding to the extracted affiliate store information and at least one of a terminal location indicated by the terminal location information and a search location indicated by the search location information may be calculated, and information about the distance may be comprised in the search result.

If the number of affiliate stores corresponding to the extracted affiliate store information exceeds a threshold, affiliate store information of as many affiliate stores as the threshold may be selected from the extracted affiliate store information according to the information about the distance.

To extract the affiliate store information, affiliate store information of at least one affiliate store matching the received search condition information from among affiliate stores located within a predetermined range may be extracted from the database.

The transaction count information may comprise at least one of the number of credit card transactions and the number of cash transactions.

The affiliate store information may comprise at least one of affiliate store name information, phone number information, address information, business type information, menu information, price information, business hour information, and parking availability information.

### BRIEF DESCRIPTION OF THE DRAWINGS

The above features and advantages of certain embodiments of the present invention will be more apparent from the following detailed description taken in conjunction with the accompanying drawings, in which:

FIG. 1 illustrates the configuration of a system for providing affiliate store information according to an embodiment of the present invention;

FIG. 2 is a block diagram of a server for providing affiliate store information according to an embodiment of the present invention;

FIG. 3 illustrates the structure of a database in the server for providing affiliate store information according to an embodiment of the present invention;

FIG. 4 is a flowchart illustrating a method for providing affiliate store information according to an embodiment of the present invention;

FIG. 5 is a flowchart illustrating a method for providing affiliate store information according to another embodiment of the present invention;

FIG. 6 is a flowchart illustrating a method for providing affiliate store information according to a further embodiment of the present invention; and

FIG. 7 illustrates exemplary User Interface (UI) screens in a mobile communication terminal according to an embodiment of the present invention.

Throughout the drawings, the same drawing reference numerals will be understood to refer to the same elements, features and structures.

### DETAILED DESCRIPTION OF THE INVENTION

Hereinafter; for the purposes of clarity and simplicity, a detailed description of a generally known function and structure of the present invention will be avoided as it may obscure the subject matter of the present invention. The terms described below are defined in connection with the function of the present invention. The meaning of the terms may vary according to the user, the intention of the operator, usual practice, etc. Therefore, the terms should be defined based on the description rather than the specification. In addition, it is clearly understood to those skilled in the art that components are appropriately, collectively or separately named in order to given an efficient description of the key technical features of the present invention, but the specific terms do not limit the scope and spirit of the present invention.

Now, a detailed description will be given of a method for managing information about an affiliate store (i.e. affiliate store information) based on the number of transactions made in the affiliate store and extracting information about an affiliate store from information about a plurality of affiliate stores according to an embodiment of the present invention. In addition, a method for extracting information about an affiliate store based on at least one of a search location and a terminal location from information about a plurality of affiliate stores according to an embodiment of the present invention will be described.

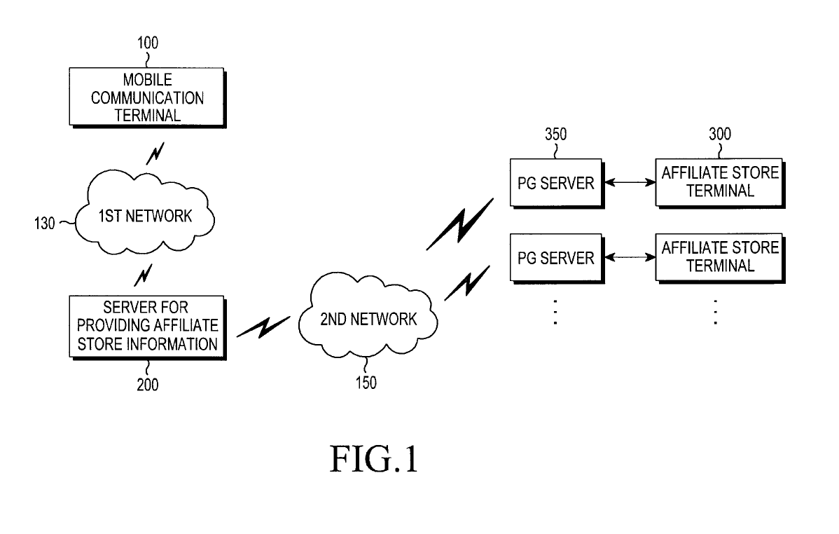

FIG. 1 illustrates the configuration of a system for providing affiliate store information according to an embodiment of the present invention.

Referring to FIG. 1, the system for providing affiliate store information comprises a mobile communication terminal 100, a server 200 for providing affiliate store information (hereinafter, shortly referred to as a server 200), an affiliate store terminal 300, and a Payment Gateway (PG) server 350.

In operation, the mobile communication terminal 100 generates search condition information and transmits the search condition information to the server 200. The search condition information is information required to search for affiliate store information. The search condition information may be replaced with a search keyword. For example, the search condition information may comprise at least one of name information, business type information, menu information, search location information, and terminal location information. Here, the name information may indicate the name of an affiliate store. The business type information may indicate the business type of the affiliate store, such as a clinic, a restaurant, a bank, etc. The menu information may specify a cuisine type or menus that are available in the affiliate store. The search location information, for example, may indicate a specific region input that a user enters to search for an affiliate store. The terminal location information may indicate the current location of the mobile communication terminal 100.

Affiliate store information describes an affiliate store, including, for example, at least one of name information, affiliate store identification information, phone number information, address information, business type information, menu information, price information, business hour information, and parking availability information. The affiliate store identification information identifies the affiliate store, indicating an identification code or number, for example. The phone number information may specify a phone number of the affiliate store and the price information may specify the prices of menus or services. The business hour information specifies hours of the operation of the affiliate store. The parking availability information indicates whether parking is available in the affiliate store.

The mobile communication terminal 100 supports a User Interface (UI) to allow the user to enter search information regarding an affiliate store. For instance, when the user executes an application for searching for affiliate store information, the mobile communication terminal 100 may display a UI to receive search information regarding an affiliate store from the user. The user enters information required to search for an affiliate store through the UI displayed on the mobile communication terminal 100. The mobile communication terminal 100 generates search condition information based on the received search information and transmits the search condition information to the server 200.

Meanwhile, the mobile communication terminal 100 determines its location through an external device (not shown) and generates terminal location information based on the determined location. For example, the external device may be a Home Location Register (HLR). Terminal location information is generated upon user setting of a location service. The location service may be set through a UI on the mobile communication terminal 100.

Alternatively or additionally, the mobile communication terminal 100 determines its location using a device comprised in the mobile communication terminal 100. The mobile communication terminal 100 generates terminal location information based on the determined location. For example, the device comprised in the mobile communication terminal 100 may be a Global Positioning System (GPS) device.

The mobile communication terminal 100 transmits search condition information including the terminal location information to the server 200.

The mobile communication terminal 100 may be any type of a terminal as long as it can receive search information regarding an affiliate store from a user and transmit search condition information to the server 200 by communicating with the server 200. The mobile communication terminal 100 may be, for example, a terminal capable of voice call or video call such as a Wideband Code Division Multiple Access (WCDMA) phone, a smart phone, etc. or a terminal such as an MPGE Audio Layer-3 (MP3) player, a Portable Multimedia Player (PMP), a portable game console, a Personal Digital Assistant (PDA), a table PC, a desktop, a laptop, an e-book, a Netbook, etc.

The server 200 extracts affiliate store information based on the search condition information and transmits search result to the mobile communication terminal 100. That is, the server 200 is connected to the mobile communication terminal 100 through a first network 130. The first network 130 may be one of a mobile communication network, a Mobile Internet, and a Wireless Local Area Network (WLAN) according to the type of a wireless communication scheme in which the first network 130 is connected to the mobile communication terminal 100. The mobile communication network may operate in CDMA or High-Speed Downlink Packet Access (HSDPA), the Mobile Internet may conform to Institute of Electrical and Electronics Engineers (IEEE) 802.16x, and the WLAN may conform to IEEE 802.11x. The first network 130 may be any future-proposed type of a wireless communication network, including a specific air interface.

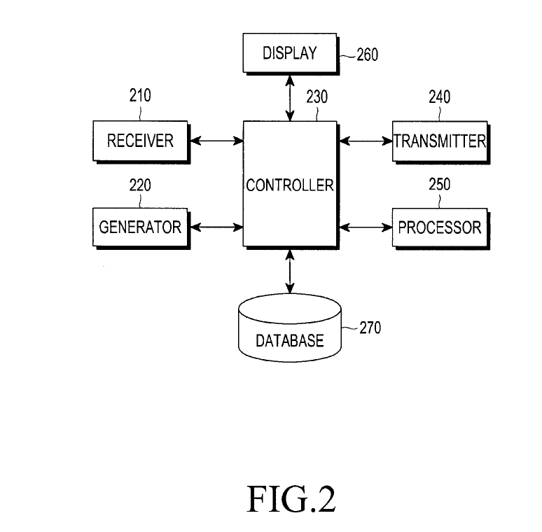

The server 200 is connected to at least one PG server 350 and collects transaction count information including at least one of the number of credit card transactions and the number of cash transactions for each affiliate store from the PG server 350. The server 200 stores and manages affiliate store information based on the transaction count information. The server 200 extracts affiliate store information matching the search condition information from the stored affiliate store information and generates search result using the extracted affiliate store information. The server 200 will be described later in greater detail with reference to FIG. 2.

The affiliate store terminal 300 processes payment by credit card or outputs a cash receipt. For this purpose, the affiliate store terminal 300 checks card identification information in a credit card. The affiliate store terminal 300 transmits a card payment request to the PG server 350 in order to make a payment. The card payment request may comprise the card identification information acquired from the credit card, a charge, and affiliate store identification information. The card identification information identifies the credit card and thus may comprise a card number. The affiliate store identification information, which identifies an affiliate store, may be an identification code or number. Upon receipt of approval for the payment from the PG server 350, the affiliate store terminal 300 may notify payment approval on a display. The reason for indicating payment approval on the display is to notify the user or the proprietor of the affiliate store that the payment has been approved.

In case of cash payment, the affiliate store terminal 300 transmits a cash receipt request to the PG server 350. The cash receipt request is generated to request a cash receipt and may comprise user authentication information, a charge, and affiliate store identification information. The user authentication information is needed for user authentication in issuing the cash receipt. The user authentication information may comprise any of a resident registration number, a subscriber phone number, and card identification information that were preliminarily registered to the National Tax Service (NTS). The affiliate store terminal 300 receives cash receipt approval from the PG server 350. Then, the affiliate store terminal 300 may print out a cash receipt such as on paper based on the cash receipt approval.

In addition, the affiliate store terminal 300 transmits a cash payment completion message to the PG server 350. The cash payment completion message notifies the PG server 350 of cash payment completion at the affiliate store and may comprise the charge and the affiliate store identification information.

The PG server 350 provides a payment proxy service between an affiliate store and a credit card company. Specifically, upon receipt of a card payment request from the affiliate store terminal 300, the PG server 350 transmits a card payment request to a credit card company server (not shown) based on the received card payment request. Upon receipt of approval for the card payment request from the credit card company server, the PG server 350 transmits the payment approval to the affiliate store terminal 300.

The PG server 350 counts the number of credit card transactions for each affiliate store. Particularly, the number of credit card transactions is counted upon receipt of a card payment request from the affiliate store terminal 300. For example, upon receipt of a card payment request from the affiliate store terminal 300, the PG server 350 checks the affiliate store identification information of the affiliate store terminal 300 and detects affiliate store information matching the affiliate store identification information from affiliate store information of a plurality of affiliate stores. Then, the PG server 350 may update the number of credit card transactions for an affiliate store corresponding to the detected affiliate store information by adding the credit card transaction count to the number of credit card transactions in the affiliate store information.

Meanwhile, upon receipt of a cash receipt request from the affiliate store terminal 300, the PG server 350 transmits a cash receipt request to an NTS server (not shown) based on the received cash receipt request. Upon receipt of approval for the cash receipt request from the NTS server after user authentication at the NTS server, the PG server 350 transmits the cash receipt approval to the affiliate store terminal 300.

The PG server 350 counts the number of cash transactions for each affiliate store. Particularly, the number of cash transactions is counted upon receipt of a cash receipt request from the affiliate store terminal 300. For example, upon receipt of a cash receipt request from the affiliate store terminal 300, the PG server 350 checks affiliate store identification information comprised in the cash receipt request and detects affiliate store information matching the affiliate store identification information from the affiliate store information of the plurality of affiliate stores. Then, the PG server 350 may update the number of cash transactions for an affiliate store corresponding to the detected affiliate store information by adding the cash transaction count to the number of cash transactions in the affiliate store information.

Upon receipt of a cash payment completion message from the affiliate store terminal 300, the PG server 350 determines that the cash payment has been completed at the affiliate store terminal 300. Then, the PG server 350 may update the number of cash transactions made at the affiliate store by adding the cash transaction count to the number of cash transactions set in the affiliate store information of the affiliate store.

The PG server 350 is connected to the server 300 through a second network 150 and transmits transaction count information including at least one of the number of credit card transactions and the number of cash transactions to the server 200 through the second network 150. The transaction count information may be transmitted to the server 200 at every predetermined interval or upon request of the server 200.

While it has been described above by way of example that transaction count information is received from the PG server 350, any other method can be implemented as far as the transaction count information can be received. For example, the server 200 may be connected to the affiliate store terminal 300 and receive transaction count information from the affiliate store terminal 300, or may receive transaction count information from another server that manages the transaction count information. In addition, while the server 200 is shown as separately configured from the PG server 350, the server 200 and the PG server 350 may be incorporated into a single device.

While the affiliate store terminal 300 is connected only to the PG server 350, this is purely exemplary. Thus, the affiliate store terminal 300 may be connected directly to the server 200.

FIG. 2 is a block diagram of the server for providing affiliate store information according to an embodiment of the present invention.

Referring to FIG. 2, the server 200 comprises a receiver 210, a generator 220, a controller 230, a transmitter 240, a processor 250, a display 260, and a database 270.

The receiver 210 is connected to the mobile communication terminal 100 through the first network 130 and receives search condition information from the mobile communication terminal 100 through the first network 130. The receiver 210 also collects information about the number of transactions made in affiliate stores, that is, transaction count information of the affiliate stores from the PG server 350. While it has been described herein that the receiver 210 receives information from the mobile communication terminal 100 and the PG server 350 by connecting to them, the receiver 210 may receive the information from entities other than the mobile communication terminal 100 and the PG server 350.

The generator 220 extracts affiliate store information based on the search condition information and generates search result using the extracted affiliate store information. More specifically, the generator 220 extracts affiliate store information of one or more affiliate stores matching the search condition information received from the mobile communication terminal 100 from affiliate store information of a plurality of affiliate stores stored in the database 270. Notably, upon receipt of the search condition information from the mobile communication terminal 100 through the receiver 210, the generator 220 extracts the affiliate store information. Then, the generator 220 generates the search result using the extracted affiliate store information. The database 270 may store affiliate store information by arranging it according to transaction counts. The search result may comprise the extracted affiliate store information in the form of a list or map. For example, if the search result is configured to comprise a list of affiliate store information, the generator 220 may arrange the extracted affiliate store information in an ascending or descending order of transaction counts. The generator 220 may arrange the extracted affiliate store information based on at least one of the numbers of credit card transactions and the numbers of cash transactions made in the affiliate stores corresponding to the extracted affiliate store information.

The generator 220 may check the transaction counts of the affiliate stores in the extracted affiliate store information and generate search result by arranging the extracted affiliate store information according to the transaction counts. The database 270 may store affiliate store information irrespective of the transaction counts of affiliate stores corresponding to the affiliate store information. Meanwhile, the generator 220 may set affiliate store information of an affiliate store having the largest transaction count as the search result or may comprise the arranged affiliate store information and the affiliate store information of the affiliate store having the largest transaction count in the search result. In other words, the search result may comprise only the affiliate store information of the affiliate store having the largest transaction count, or the arranged affiliate store information and the affiliate store information of the affiliate store having the largest transaction count.

If the number of the affiliate stores corresponding to the extracted affiliate store information exceeds a threshold, the generator 220 may select as many affiliate stores as the threshold from the affiliate stores according to their transaction counts and may generate search result with affiliate store information of the selected affiliate stores. The threshold is the number of affiliate stores required for generating search result. The threshold may be set in the search condition information received at the receiver 220 from the mobile communication terminal 100, may be preset by an operator of the server 200, or may be set by a predetermined algorithm (e.g. a program, etc.).

The generator 220 may extract, from the database 270, affiliate store information of one or more affiliate stores matching the received search condition information among affiliate stores located within a predetermined range and then may generate search result with the extracted affiliate store information. Specifically, the generator 220 extracts affiliate store information of one or more affiliate stores matching the search condition information from the database 270 and then extracts affiliate store information of one or more affiliate stores located within the predetermined range from the extracted affiliate store information. The predetermined range may be defined by a preset radius, an administrative district (e.g. on the basis of a metropolitan city, a province, a city, a county, etc.), or a facility name (e.g. a subway, a street, a park, a bus stand, etc.). The predetermined range may also be set by an operator or a predetermined algorithm (e.g. a program, statistical probabilities, etc.).

Meanwhile, the generator 220 checks at least one of terminal location information and search location information of the mobile communication terminal 100 in the received search condition information. The generator 220 may extract affiliate store information of one or more affiliate stores within a predetermined range from the database 270 based on the at least one of the terminal location information and the search location information comprised in the search condition information. The generator 220 may further extract affiliate store information of one or more affiliate stores, matching information other than the terminal location and search location information in the search condition information, from the extracted affiliate store information. For example, if the search result comprises search location information and name information, the generator 220 may extract affiliate store information based on the search location information and then further extract affiliate store information according to the name information from the extracted affiliate store information. It may be further contemplated as another embodiment that the generator 220 first extracts affiliate store information of one or more affiliate stores matching the name information from affiliate store information of a plurality of affiliate stores stored in the database 270 and then extracts affiliate store information according to the search location information from the extracted affiliate store information matching the name information.

In addition, the generator 220 calculates the distances between the one or more affiliate stores corresponding to the extracted affiliate store information and at least one of a terminal location indicated by the terminal location information and a search location indicated by the search location information in the search condition information. The generator 220 may comprise information about the distances in the search result. If the number of the affiliate stores corresponding to the extracted affiliate store information exceeds a threshold, the generator 220 may select as many affiliate stores as the threshold and generate search result using affiliate store information of the selected affiliate stores.

The server 200 may generate terminal location information. Specifically, the generator 220 may generate terminal location information by locating the mobile communication terminal 100 that has transmitted the search condition information, through an external device. The external device may be a device capable of determining the current location of the mobile communication terminal 100, such as an HLR. In the case where the search condition information received from the mobile communication terminal 100 does not comprise terminal location information and the user or the operator sets a location service, the server 200 generates the terminal location information. The generator 220 may extract affiliate store information from affiliate information of a plurality of affiliate stores according to the generated terminal location information.

The controller 230 provides overall control to the server 200. That is, the controller 230 controls the receiver 210, the generator 220, the transmitter 240, the processor 250, the display 260, and the database 170 of the server 200. For example, when the receiver 210 receives a search request from the mobile communication terminal 100 and a communication channel is established with the mobile communication terminal 100 through the first network 130, the controller 230 may control the transmitter 240 to transmit a UI to the mobile communication terminal 100. The UI may be used to receive search information regarding an affiliate store from the user. Upon receipt of transaction count information through the receiver 210, the controller 230 may identify an affiliate store corresponding to the transaction count information and control the database 270 to store the transaction count information for the affiliate store. The controller 230 controls the transmitter 240 to transmit a UI generated from the processor 250 to the mobile communication terminal 100.

The transmitter 240 is connected to the mobile communication terminal 100 through the first network 130 and transmits information to the mobile communication terminal 100 through the first network 130. Specifically, the transmitter 140 transmits to the mobile communication terminal 100 search result including affiliate store information that has been extracted based on search condition information and transaction counts. In addition, the transmitter 240 may transmit a UI to the mobile communication terminal 100 in order to receive search information regarding an affiliate store from the user through the UI.

The processor 250 processes an additional service requested by the mobile communication terminal 100. Specifically, the processor 250 generates a UI through which the user may make a reservation or an order in a selected affiliate store. The UI may be provided by an application comprised in the mobile communication terminal 100. When the user is to select one of affiliate stores in search result displayed on the mobile communication terminal 100, the processor 250 generates the UI.

Further, the processor 250 transmits reservation or order information and customer information received from the mobile communication terminal 100 to the affiliate store terminal 300. The affiliate store terminal 300 is a terminal in the affiliate store selected by the user. When the user makes a reservation or an order by the application of the mobile communication terminal 100 and the processor 250 receives the reservation or order information from the mobile communication terminal 100 through the receiver 210, the processor 250 transmits the reservation or order information and the customer information to the affiliate store terminal 300. The reservation or order information specifies a product or service that the user wants to reserve or order, for example, including a reservation date, a reservation time, affiliate store information, a menu to be reserved, subscriber identification information, etc.

The display 260 displays operation information and result information generated during operation of the server 200 to the operator. For instance, the display 260 displays search condition information received through the receiver 210 or search result generated from the generator 220.

The display 260 also displays information stored in the database 270. For example, the display 260 may display affiliate store information of a plurality of affiliate stores stored in the database 270, search condition information corresponding to the affiliate store information, and transaction counts.

Any type of device is available as the display 260, only if the device can display search condition information and affiliate store information. For example, the display 260 may be one of a Liquid Crystal Display (LCD), an Organic Light Emitting Diode (OLED) display, and an Electro Phoretic Display (EPD).

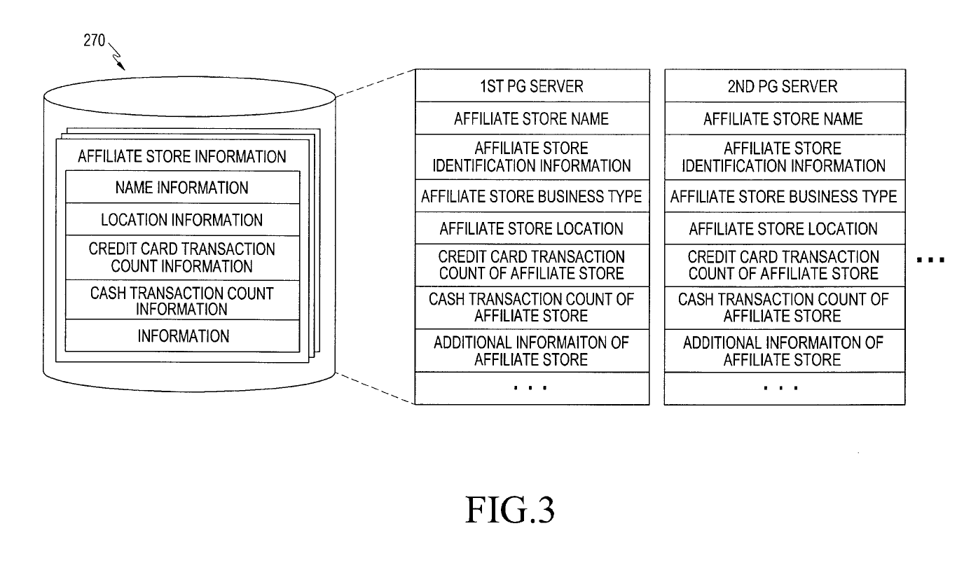

The database 270 stores programs for controlling the overall operation of the server 200, data generated during execution of the programs, and acquired data. For example, the database 270 may store search condition information needed to search for an affiliate store and affiliate store information including transaction count information, for each affiliate store. The affiliate store information may be arranged according to transaction counts in the database 270. Alternatively, affiliate store information may be stored for each of a plurality of affiliate stores in the database 270, irrespective of the transaction count of the affiliate store. The database 270 will be described with reference to FIG. 3.

The database 270 has been described as incorporated into the server 200, by way of example. The database 270 may be configured separately from the server 200. For instance, the database 270 may reside in the PG server 350 that is connected to the server 200.

FIG. 3 illustrates the structure of the database in the server for providing affiliate store information according to an embodiment of the present invention.

Referring to FIG. 3, the database 270 stores affiliate store information received from one or more PG servers 350. More specifically, the database 270 may collect information about the name, identification number, business type, location, card transaction count, and cash transaction count of each affiliate store from first and second PG servers 350 and may store the collected affiliate store information and additional information. The reason for storing affiliate store information on a PG server basis is to provide information about various affiliate stores to the user because PG servers keep transaction count information of affiliate stores and affiliate stores differ in PG servers that they deal with.

While affiliate store information is stored separately according to PG servers, this is purely exemplary. Therefore, how affiliate store information is stored does not matter, as far as the affiliate store information can be stored.

Now, methods for providing affiliate store information according to various embodiments of the present invention will be described below. Regarding the components of the server 200 according to the embodiment of the present invention as described with reference to FIG. 2, it is to be clearly understood that two or more components may be incorporated into a single component or one component may be separated into a plurality of components, and components having the afore-described functions may serve for the server 200 irrespective of their names. Accordingly, the following description is given of the methods for providing affiliate store information with the appreciation that each operation is performed by the server 200, not a specific component.

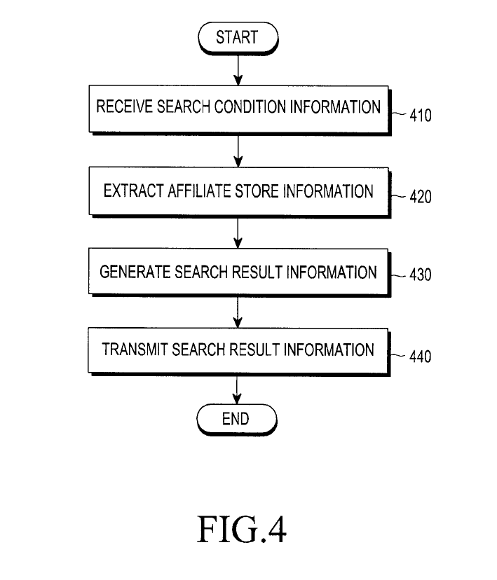

FIG. 4 is a flowchart illustrating a method for providing affiliate store information according to an embodiment of the present invention.

Referring to FIG. 4, the server 200 receives search condition information from the mobile communication terminal 100 in step 410. For instance, upon receipt of menu information “pizza” from the user, the mobile communication terminal 100 may generate search condition information including the menu information “pizza” and transmit the search condition information to the server 200. Before or after receiving the search condition information from the mobile communication terminal 100, the server 200 may collect transaction count information from each affiliate store through the PG server 350. The server 200 may store affiliate store information of one or more affiliate stores based on the transaction counts of the one or more affiliate stores.

In step 420, the server 200 extracts affiliate store information of one or more affiliate stores matching the search condition information from stored affiliate store information of a plurality of affiliate stores. For example, the server 200 may extract affiliate store information matching the menu information “pizza” comprised in the search condition information received from the mobile communication terminal 100 from the stored affiliate store information.

The server 200 checks the transaction counts of the one or more affiliate stores in the extracted affiliate store information and generates search result by arranging the extracted affiliate store information according to the transaction counts in step 430. Specifically, the server 200 generates the search result by arranging the extracted affiliate store information according to at least one of the number of credit card transactions and the number of cash transactions made in each of the one or more affiliate stores.

If the number of the one or more affiliate stores corresponding to the extracted affiliate store information exceeds a threshold, the server 200 may select as many affiliate stores as the threshold from among the one or more affiliate stores and generate search result using affiliate store information of the selected affiliate stores.

The server 200 transmits the search result to the mobile communication terminal 100 in step 440.

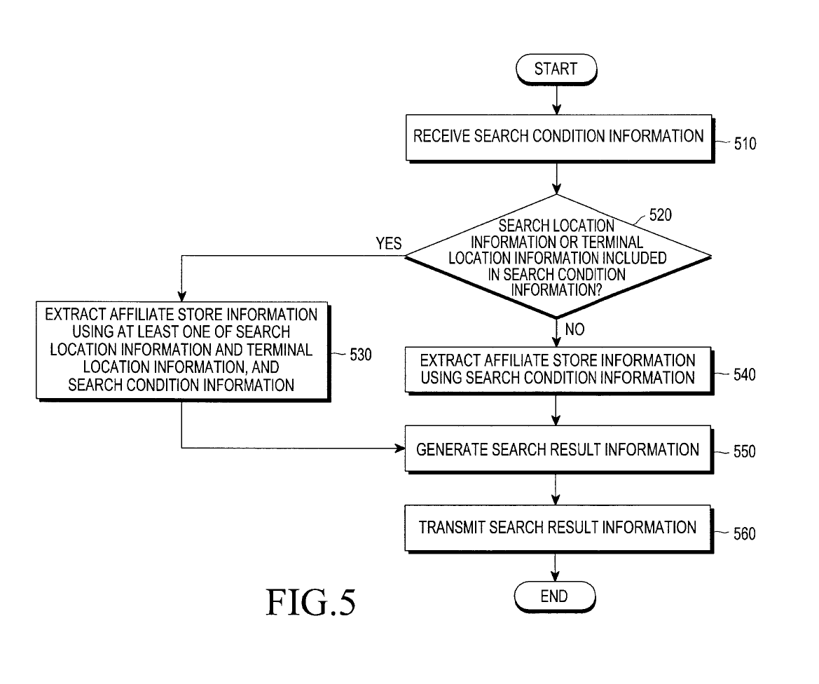

FIG. 5 is a flowchart illustrating a method for providing affiliate store information according to another embodiment of the present invention.

Referring to FIG. 5, the server 200 receives search condition information from the mobile communication terminal 100 in step 510. For example, the mobile communication terminal 100 may comprise search location information “Seoul Station” and menu information “pizza” in the search condition information and transmit the search condition information to the server 200.

The server 200 determines whether the search condition information comprises search location information or terminal location information in step 520.

In the presence of at least one of search location information and terminal location information in the search condition information, the server 200 extracts affiliate store information of one or more affiliate stores based on the search condition information and the at least one of search location information and terminal location information in step 530. Specifically, if the search condition information comprises at least one of search location information and terminal location information, the server extracts affiliate store information of one or more affiliate stores located within a predetermined range from stored affiliate store information of a plurality of affiliate stores, according to the at least one of the terminal location information and the search location information. For example, the server may extract affiliate store information of one or more affiliate stores located within the predetermined range from “Seoul Station” set in the search condition information from the stored affiliate store information of the plurality of affiliate stores.

The server 200 further extracts affiliate store information of one or more affiliate stores from the extracted affiliate store information according to information other than the search location information and the terminal location information in the search condition information. For example, the server may extract affiliate store information of one or more affiliate stores matching the menu information “pizza” from the extracted affiliate information matching “Seoul Station”.

Meanwhile, the server 200 may first extract affiliate store information of one or more affiliate stores matching information other than the search location information and the terminal location information from the stored affiliate store information of the plurality of affiliate stores and then may extract affiliate store information from the extracted affiliate store information according to at least one of the search location information and the terminal location information.

The server 200 may calculate the distances between affiliate stores corresponding to the extracted affiliate store information and at least one of a terminal location indicated by the terminal location information and search location information indicated by the search location information and may comprise information about the distances in search result.

If the search condition information comprises neither search location information nor terminal location information, the server 200 extracts affiliate store information of one or more affiliate stores matching the search condition information from the stored affiliate store information in step 540.

In step 550, the server 200 generates search result by arranging the extracted affiliate store information according to at least one of the number of credit card transactions and the number of cash transactions made in each of affiliate stores corresponding to the extracted affiliate store information.

The server 200 transmits the search result to the mobile communication terminal 100 that transmitted the search condition information in step 560.

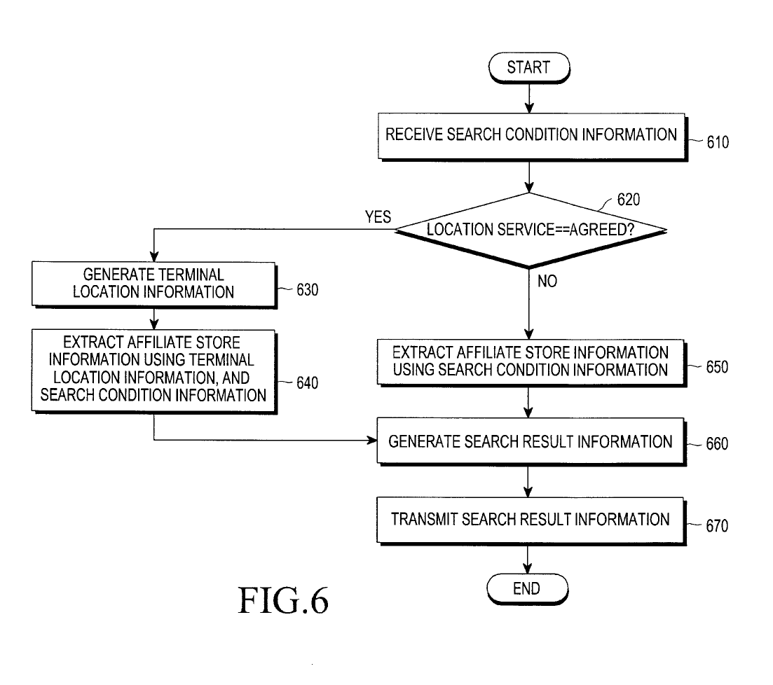

FIG. 6 is a flowchart illustrating a method for providing affiliate store information according to a further embodiment of the present invention.

Referring to FIG. 6, the server 200 receives search condition information from the mobile communication terminal 100 in step 610. The server 200 collects information about the number of transactions made in each affiliate store, that is, transaction count information of each affiliate store.

In step 620, the server 200 determines whether the search condition information indicates that a location service has been agreed. Herein, the search condition information does not comprise terminal location information.

If the location service has been agreed, the server 200 generates terminal location information by locating the mobile communication terminal 100 that transmitted the search condition information in step 630.

The server 200 extracts affiliate store information of one or more affiliate stores that are located in a predetermined range from the location of the mobile communication terminal 100 and match the received search condition information, from stored affiliate store information of a plurality of affiliate stores in step 640.

On the other hand, if the location service has not been agreed, the server 200 extracts affiliate store information of one or more affiliate stores matching the search condition information received from the mobile communication terminal 100, from the stored affiliate store information in step 650.

In step 660, the server 200 generates search result by arranging the extracted affiliate store information according to the number of transactions made in each of affiliate stores corresponding to the extracted affiliate store information.

The server 200 transmits the search result to the mobile communication terminal 100 in step 670.

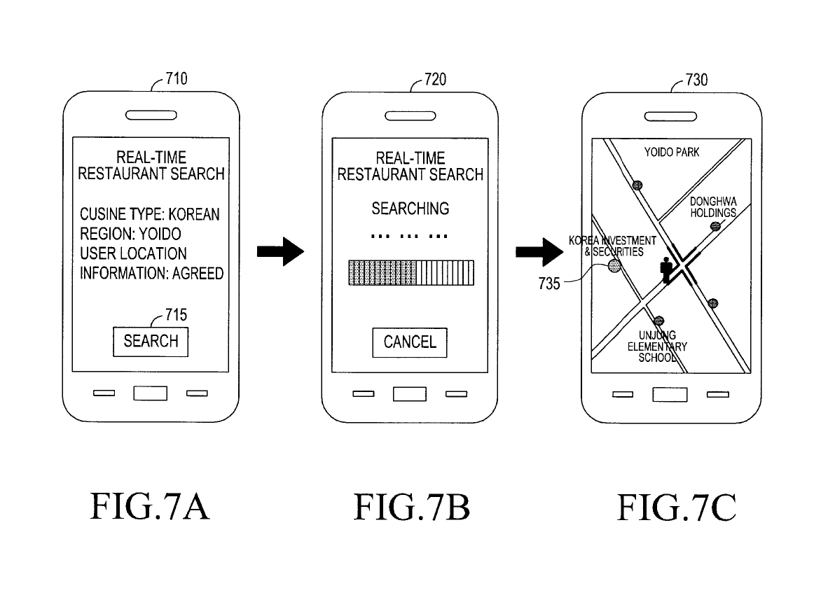

FIG. 7 illustrates exemplary UI screens in a mobile communication terminal according to an embodiment of the present invention.

The following description is given with the appreciation that affiliate store information is provided as a “real-time restaurant search” service, by way of example.

When the user executes a real-time restaurant search application installed in the mobile communication terminal 100, the mobile communication terminal 100 displays a UI screen 710 for entering information to search for a restaurant, as illustrated in (a) of FIG. 7. For example, if the user enters Korean for Cuisine Type and Yoido for Region the mobile communication terminal 100 may display KOREAN as CUISINE TYPE, YOIDO as REGION. And, if the user agrees a location service, the mobile communication terminal 100 may display AGREED as USER LOCATION INFORMATION.

After the user completely enters information for searching for an affiliate store on the UI screen 710, the user selects a search icon 715 on the UI screen 710. Then, the mobile communication terminal 100 displays a screen 720 indicating that the restaurant search information received from the user is being sent to the server 200, as illustrated in (b) of FIG. 7. Because the user has agreed the location service, the mobile communication terminal 100 may generate terminal location information by determining its location and transmit the terminal location information to the server 200.

The mobile communication terminal 100 receives affiliate store information based on transaction counts, which matches the user-input information, from the server 200. As illustrated in (c) of FIG. 7, the mobile communication terminal 100 displays a screen 730 including the affiliate store information. For instance, the mobile communication terminal 100 may mark affiliate stores corresponding to the affiliate store information as spots 735 as illustrated in (c) of FIG. 7. In addition, the mobile communication terminal 100 may differentiate the sizes of the spots 735 according to the transaction counts of the affiliate stores as illustrated in (c) of FIG. 7. That is, a large spot is marked for an affiliate store having a large number of transactions, whereas a small spot is marked for an affiliate store having a small number of transactions.

While affiliate store information is indicated on a map in (c) of FIG. 7, to which the present invention is not limited, any form is available as far as affiliate store information can be displayed. For example, the mobile communication terminal 100 may display the affiliate store information by sequentially arranging it according to the transaction counts of the affiliate stores.

In addition, while restaurants are searched for in the example of FIG. 7, the same thing applies to a search for any affiliate store type that makes credit card and cash transactions, such as an affiliate store that sells miscellaneous items like fashion items, a clinic, a drug store, etc.

The above-described methods according to the present invention can be implemented in hardware, firmware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A server for providing affiliate store information, comprising:
a receiver for collecting transaction count information relating to a number of transactions made in each affiliate store and receiving search condition information from a mobile communication terminal;
a database for storing affiliate store information generated based on the collected transaction count information according to a predetermined criteria;
a generator for extracting the affiliate store information of at least one affiliate store from the database according to the search condition information and generating a search result using the extracted affiliate store information; and
a transmitter for transmitting the search result to the mobile communication terminal.

2. The server of claim 1, wherein the generator checks the number of transactions made in the at least one affiliate store using the extracted affiliate store information and generates the search result by arranging the extracted affiliate store information according to the checked number of transactions.

3. The server of claim 2, wherein if the number of affiliate stores corresponding to the extracted affiliate store information exceeds a threshold, the generator selects the affiliate store information of as many affiliate stores as the threshold from the extracted affiliate store information according to the numbers of transactions made in the affiliate stores.

4. The server of claim 3, wherein the threshold is received in the search condition information from the mobile communication terminal, or preset by an operator of the server.

5. The server of claim 2, wherein the generator extracts the affiliate store information of the at least one affiliate store from the database using at least one of terminal location information of the mobile communication terminal and search location information, the terminal location information and the search location information being acquired from the search condition information.

6. The server of claim 5, wherein the generator calculates the distance between the at least one affiliate store corresponding to the extracted affiliate store information and at least one of a terminal location indicated by the terminal location information and a search location indicated by the search location information and comprises information about the distance in the search result.

7. The server of claim 6, wherein if the number of affiliate stores corresponding to the extracted affiliate store information exceeds a threshold, the generator selects affiliate store information of as many affiliate stores as the threshold from the extracted affiliate store information according to the information about the distance.

8. The server of claim 2, wherein the generator extracts the affiliate store information of at least one affiliate store matching the received search condition information from among affiliate stores located within a predetermined range from the database.

9. The server of claim 1, wherein the transaction count information comprises at least one of the number of credit card transactions and the number of cash transactions.

10. The server of claim 1, wherein the affiliate store information comprises at least one of affiliate store name information, phone number information, address information, business type information, menu information, price information, business hour information, and parking availability information.

11. A method for providing affiliate store information in a server, the method comprising:
generating affiliate store information based on collected transaction count information of each affiliate store, the transaction count information relating to the number of transactions made in the affiliate store and managing the affiliate store information in a database;
extracting the affiliate store information of at least one affiliate store from a database according to search condition information received from a mobile communication terminal;
generating a search result using the extracted affiliate store information; and
transmitting the search result to the mobile communication terminal.

12. The method of claim 11, wherein the search result generation comprises:
checking the number of transactions made in the at least one affiliate store using the extracted affiliate store information;
arranging the extracted affiliate store information according to the checked number of transactions; and
generating the search result using the arranged affiliate store information.

13. The method of claim 11, wherein the search result generation comprises, if the number of affiliate stores corresponding to the extracted the affiliate store information exceeds a threshold, extracting affiliate store information of as many affiliate stores as the threshold from the extracted affiliate store information according to the numbers of transactions made in the affiliate stores.

14. The method of claim 13, wherein the threshold is received in the search condition information from the mobile communication terminal, or preset by an operator of the server.

15. The method of claim 11, wherein the affiliate store information extraction comprises extracting the affiliate store information of the at least one affiliate store from the database using at least one of terminal location information of the mobile communication terminal and search location information, the terminal location information and the search location information being acquired from the search condition information.

16. The method of claim 15, wherein the search result generation comprises:
calculating the distance between the at least one affiliate store corresponding to the extracted affiliate store information and at least one of a terminal location indicated by the terminal location information and a search location indicated by the search location information; and
including information about the distance in the search result.

17. The method of claim 16, wherein the search result generation comprises, if the number of affiliate stores corresponding to the extracted affiliate store information exceeds a threshold, selecting affiliate store information of as many affiliate stores as the threshold from the extracted affiliate store information according to the information about the distance.

18. The method of claim 12, wherein the affiliate store information extraction comprises extracting affiliate store information of at least one affiliate store matching the received search condition information from among affiliate stores located within a predetermined range, from the database.

19. The method of claim 11, wherein the transaction count information comprises at least one of the number of credit card transactions and the number of cash transactions.

20. The method of claim 11, wherein the affiliate store information comprises at least one of affiliate store name information, phone number information, address information, business type information, menu information, price information, business hour information, and parking availability information.
